(19) United States
(12) Patent Application Publication
(10) Pub. No.: US 2021/0194000 A1
(43) Pub. Date: Jun. 24, 2021

(54) METHOD OF PRODUCING COMPOSITE ACTIVE MATERIAL

(71) Applicant: TOYOTA JIDOSHA KABUSHIKI KAISHA, Toyota-shi (JP)

(72) Inventor: Takayuki UCHIYAMA, Susono-shi (JP)

(21) Appl. No.: 16/953,406

(22) Filed: Nov. 20, 2020

(30) Foreign Application Priority Data
Dec. 20, 2019 (JP) 2019-230661

(51) Int. Cl. H01M 4/58; H01M 4/04; H01M 4/36; H01M 10/0525

(52) U.S. Cl. CPC H01M 4/58; H01M 10/0525; H01M 4/366; H01M 4/0471

(57) ABSTRACT

Provided is a method of producing a composite active material that makes it possible to suppress aggregation of an active material in a process of coating with Li₃PO₄ to improve a discharge capacity. The method causes a neutralization reaction of a basic Li source and an acidic PO₄ source on a surface of a particulate active material, to coat at least part of the surface of the active material with Li₃PO₄.

### FIELD

The present application relates to a method of producing a composite active material.

### BACKGROUND

A conventional problem in fields pertaining to lithium ion batteries is to have a higher-capacity battery. For example, use of a high-potential cathode active material may lead to a reaction of the cathode active material and an electrolyte to lower the capacity of the battery, which is problematic.

For such a problem, Patent Literature 1 discloses a technique of suppressing a degradation reaction of an organic electrolyte by a membrane of an inorganic solid electrolyte which is formed in advance between a cathode material and the organic electrolyte in a secondary battery including the cathode material, an anode material, and the organic electrolyte between the cathode and anode materials.

Patent Literature 1 also describes spraying an ethanol solution containing lithium nitrate (LiNO₃) and phosphoric acid (H₃PO₄) over a surface of the layered cathode material by the ESD process (electrostatic spray deposition process) to precipitate Li₃PO₄ as a method of forming the membrane of an inorganic solid electrolyte. Patent Literature 1 describes, as the cathode material, a spinel-type NiMn-based cathode active material that is a high-potential cathode active material.

### CITATION LIST

### Patent Literature

Patent Literature 1: JP 2003-338321 A

### SUMMARY

### Technical Problem

In Patent Literature 1, Li₃PO₄ is precipitated on the surface of the layered cathode material by the ESD process using the ethanol solution containing lithium nitrate and phosphoric acid to form the membrane of an inorganic solid electrolyte. In contrast, the inventor of the present application found that if Li₃PO₄ is precipitated on a surface of a particulate active material by the tumbling fluidized coating method using the foregoing ethanol solution, so that the surface of the active material is coated with Li₃PO₄, the active material is aggregated, which is problematic. This is because, in the process of drying up the active material, the viscosity of the ethanol solution, which is a coating liquid, increases on the surface of the active material, and thus the ethanol solution functions as a binder to bind the active material. The active material is presumed to be bound by unreacted phosphoric acid. Aggregation of the active material causes a problem of a lowered discharge capacity.

With the foregoing actual circumstances in view, a purpose of the present application is to provide a method of producing a composite active material that makes it possible to suppress aggregation of an active material in a process of coating with Li₃PO₄ to improve a discharge capacity.

### Solution to Problem

To achieve such a purpose, the present application discloses, as one means, a method of producing a composite active material, wherein the method causes a neutralization reaction of a basic Li source and an acidic PO₄ source on a surface of a particulate active material, to coat at least part of the surface of the active material with Li₃PO₄.

The foregoing method may comprise: a Li source adhering step of adhering the Li source to the surface of the active material; and a PO₄ source adhering step of adhering the PO₄ source to the surface of the active material, the PO₄ source adhering step following the Li source adhering step, and in this case, the PO₄ source may be H₃PO₄. The method may further comprise: a drying step of carrying out heat treatment on the active material, the surface of the active material being coated with Li₃PO₄, at a temperature at which the active material is not degraded.

### Advantageous Effects

The present disclosure makes it possible to produce a composite active material having an improved discharge capacity which makes it possible to suppress aggregation of an active material.

### BRIEF DESCRIPTION OF DRAWINGS

FIG. 1 is a flowchart of a method 10 of producing a composite active material;

FIG. 2 is a schematic cross-sectional view of a composite active material 100;

FIG. 3 is an explanatory graph showing the relation between thickness of a coating layer and average particle size concerning composite active materials according to Examples 1 to 9 and Comparative Examples 1 to 6; and

FIG. 4 is an explanatory graph showing the relation between heat treatment temperature and discharge capacity concerning all-solid-state batteries according to Examples 4 to 9 and Comparative Examples 2 to 6.

### DESCRIPTION OF EMBODIMENTS

The method of producing a composite active material according to the present disclosure causes a neutralization reaction of a basic Li source and an acidic PO₄ source on a surface of a particulate active material, to coat at least part of the surface of the active material with Li₃PO₄. The method of producing a composite active material according to the present disclosure makes it possible to produce a composite active material having an improved discharge capacity which leads to suppression of aggregation of an active material.

Hereinafter the method of producing a composite active material according to the present disclosure will be described using a method 10 of producing a composite active material (hereinafter may be referred to as “production method 10”) which is one embodiment.

[Method 10 of Producing Composite Active Material]

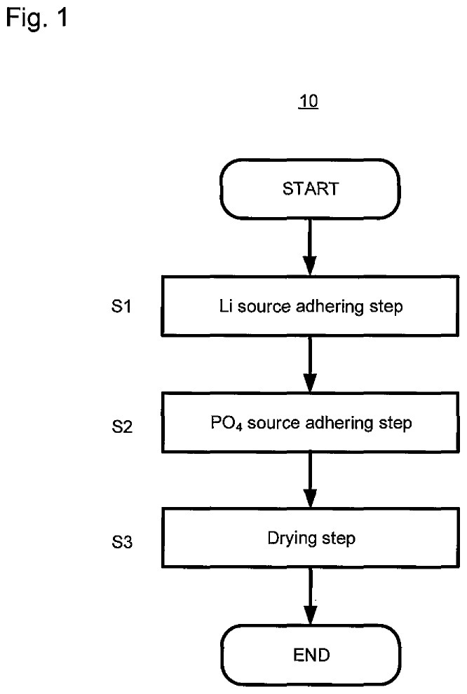

FIG. 1 shows a flowchart of the method 10 of producing a composite active material. As shown in FIG. 1, the producing method 10 includes a Li source adhering step S1 and a PO₄ source adhering step S2. This makes it possible to cause the neutralization reaction of the basic Li source and the acidic PO₄ source on the surface of the particulate active material, to coat at least part of the surface of the active material with Li₃PO₄. The production method 10 also includes a drying step S3 that is an optional step.

<Li Source Adhering Step S1>

The Li source adhering step S1 is a step of adhering the basic Li source to the surface of the particulate active material. This makes it possible to adhere the basic Li source to at least part of the surface of the particulate active material or to the entire surface thereof.

For example, the tumbling fluidized coating method can be used as a method of adhering the Li source to the surface of the active material particle which is not particularly limited thereto though. The tumbling fluidized coating method can be performed by a known coater. Various conditions in the tumbling fluidized coating method can be suitably set in view of, for example, the thickness of a coating layer (Li₃PO₄) to be aimed. In the tumbling fluidized coating method, the Li source is sprayed over the surface of the active material using a solution (or aqueous solution) in which the Li source is dissolved in a solvent, to be adhere to the surface of the active material particle. The solvent is not particularly limited, but an example thereof is water in view of solubility of the Li source. The concentration of the solution can be suitably set in view of the reaction with the PO₄ source described later. In view of promoting the neutralization reaction with the PO₄ source to suppress aggregation of the active material, the concentration may be adjusted so that pH of the solution is at least 10. Further, in view of promoting the neutralization reaction, the concentration may be adjusted so that pH of the solution is at least 12.

The Li source is a basic compound having composition including Li as a cation. Specific examples of the Li source include LiOH, Li₂CO₃, LiNO₃ and Li₂SO₄. In view of promoting the neutralization reaction with the PO₄ source, which will be described later, to suppress aggregation of the active material, LiOH or Li₂CO₃ may be used, and among them, LiOH having a further high basicity may be used as the Li source.

The active material is not particularly limited, but examples thereof include metal oxides each containing lithium and at least one transition metal selected from manganese, cobalt, nickel and titanate. Specific examples thereof include lithium cobaltate (LiₓCoO₂), lithium nickel manganese oxide (LiNiₐMn_{b}O₄ where a and b satisfy 0<a<2, 0<b<2 and a+b=2) and lithium nickel cobalt manganese oxide (LiNiₓCo_{y}Mn_{z}O₂ where x, y and z satisfy 0<x<1, 0<y<1, 0<z<1 and x+y+z=1). For the active material, one of them may be used alone, or two or more of them may be used in combination. In view of improving discharge capacity, either LiNiₐMn_{b}O₂ or LiNiₓCo_{y}Mn_{z}O₂ may be used.

The active material is in the form of a particle. The average particle size of the active material is not particularly limited, but examples thereof include average particle sizes of at least 1 μm, at least 3 μm, at least 5 μm, and at least 10 μm, and at most 100 μm, at most 50 μm, at most 30 μm, and at most 20 μm in view of enlarging the contact area of the solid-solid interface. Specific examples of the range of the average particle size of the active material include the ranges of 1 μm to 50 μm, 1 μm to 20 μm, 1 μm to 10 μm and 1 μm to 6 μm.

Here, “average particle size” is D₅₀ measured by a particle counter based on the laser diffraction method unless otherwise especially mentioned.

<PO₄ Source Adhering Step S2>

The PO₄ source adhering step S2 is a step of adhering the acidic PO₄ source to the surface of the active material, the PO₄ source adhering step S2 following the Li source adhering step S1. This makes it possible to adhere the PO₄ source to at least part of the surface of the active material or to the entire surface thereof. Since the Li source is adhered to the surface of the active material in the Li source adhering step S1, further adhesion of the PO₄ source to the surface in the PO₄ source adhering step S2 can lead to the neutralization reaction of the Li source and the PO₄ source on the surface of the active material to precipitate Li₃PO₄.

The method of adhering the PO₄ source to the surface of the active material particle is the same as in the Li source adhering step S1. When the PO₄ source is sprayed over the surface of the active material using a solution (aqueous solution) in which the PO₄ source is dissolved in a solvent (for example, water) to be adhered to the surface, the concentration of the solution may be adjusted so that pH of the solution is at most 4 in view of promoting the neutralization reaction with the Li source to suppress aggregation of the active material; and further, may be adjusted so that pH of the solution is at most 2 in view of promoting the neutralization reaction.

The PO₄ source is an acidic compound having composition including PO₄ as an anion. A specific example of the PO₄ source is H₃PO₄.

As described above, the production method 10 causes the neutralization reaction of the basic Li source and the acidic PO₄ source on the surface of the particulate active material, to coat at least part of the surface of the active material with Li₃PO₄. Precipitation of Li₃PO₄ on the surface of the active material using the neutralization reaction as described above makes it possible to form a Li₃PO₄ layer without heat treatment, which can suppress aggregation of the active material caused by an unreacted Li source or PO₄ source, especially an unreacted PO₄ source.

<Drying step S3>

The drying step S3 is a step of carrying out heat treatment on the active material, the surface of the active material being coated with Li₃PO₄, at a temperature at which the active material is not degraded. The drying step S3 is an optional step, and is carried out for removing the solvent when any solvent is adhered to the active material obtained through the Li source adhering step S1 and the PO₄ source adhering step S2. Thus, in the drying step S3, the active material has only to be dried up so that the solvent can be removed. This is because high-temperature processing is unnecessary since Li₃PO₄ is precipitated on the surface of the active material obtained in the PO₄ source adhering step S2 by the neutralization reaction, as described above.

The lowest drying temperature is not particularly restricted. In view of efficiently removing solvent, the drying temperature may be at least 100° C., or may be at least 200° C. High-temperature processing may be carried out in view of the presence of an unreacted portion. Even in this case, it is important to carry out high-temperature processing at a temperature at which the active material is not degraded. The temperature at which the active material is degraded varies according to the composition of the active material. For example, the drying temperature may be at most 600° C., may be at most 500° C., or may be at most 400° C.

The drying time of the active material may be, but is not particularly limited to, 10 minutes to 24 hours. The active material may be dried up in the air, in an inert gas, or in a reduced pressure (high vacuum).

<Supplement>

In the method 10 of producing a composite active material, at least part of the surface of the active material is coated with Li₃PO₄. The method of producing a composite active material according to the present disclosure is not limited to this, and the entire surface of the active material may be coated with Li₃PO₄. In the method 10 of producing a composite active material, the Li source adhering step S1 is followed by the PO₄ source adhering step S2. The method of producing a composite active material according to the present disclosure is not limited to this, and the PO₄ source adhering step S2 may be followed by the Li source adhering step S1, or the Li source adhering step S1 and the PO₄ source adhering step S2 may be carried out at the same time. When H₃PO₄ is used as the PO₄ source, the Li source adhering step S1 may be followed by the PO₄ source adhering step S2 in view of suppressing aggregation of the active material.

[Composite Active Material]

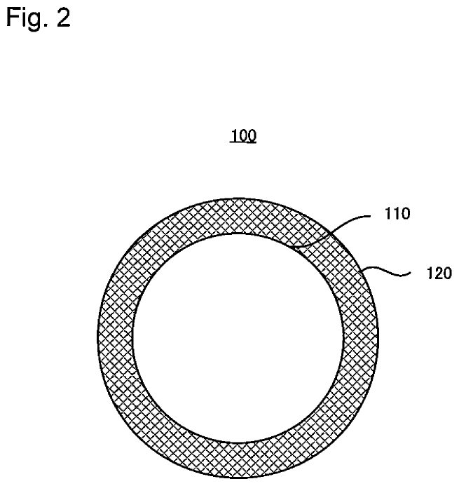

A composite active material obtained by the method of producing a composite active material according to the present disclosure will be described. FIG. 2 shows a composite active material 100 that is one example of the composite active material. The composite active material 100 has an active material 110, and a coating layer 120 arranged on a surface of the active material 110. The effect of coating is obtained as long as the coating layer 120 is arranged on at least part of the surface of the active material 110. The coating layer 120 may be arranged on the entire surface as shown in FIG. 2 though. The active material 110 can be formed of the foregoing materials. The coating layer 120 is a layer containing Li₃PO₄.

The composite active material 100 is in the form of a particle. The average particle size of the composite active material 100 is not particularly limited to, but examples thereof include average particle sizes of at least 1 μm, at least 3 μm, at least 5 μm, and at least 10 μm, and at most 100 μm, at most 50 μm, at most 30 μm, and at most 20 μm, in view of enlarging the contact area of the solid-solid interface. Specific examples of the range of the average particle size of the composite active material include the ranges of 1 μm to 50 μm, 1 μm to 20 μm, 1 μm to 10 μm and 1 μm to 6 μm.

Examples of the range of the thickness of the coating layer 120 include the ranges of 1 nm to 100 nm, 1 nm to 50 nm, 1 nm to 20 nm, and 1 nm to 10 nm. The thickness of the coating layer 120 can be measured using, for example, a transmission electron microscope (TEM). The coating amount is measured by an ICP analyzer or calculated from the amount of the sprayed coating liquids, which also makes it possible to calculate the thickness from the specific surface area of the active material, and the density of the coating layer.

Since the surface of the active material 110 is coated with the coating layer 120 in the composite active material 100, a reaction of the active material and an electrolyte can be suppressed when the composite active material 100 is applied to a battery. The composite active material 100 can be used as a cathode active material for batteries, and among them, is preferably used as a cathode active material for all-solid-state lithium ion batteries.

### EXAMPLES

Hereinafter the method of producing a composite active material according to the present disclosure will be further described using Examples.

### Examples 1 to 9

### <Making Composite Active Material>

First, 500 g of a LiOH aqueous solution was made by adding water to 34.5 g of LiOH.H₂O (manufactured by Nacalai Tesque, Inc.). In addition, 500 g of a phosphoric acid aqueous solution was made by adding water to 31.6 g of a 85% phosphoric acid (manufactured by Nacalai Tesque, Inc.).

Next, the LiOH aqueous solution and the phosphoric acid aqueous solution were sprayed in the order mentioned over 1 kg of a cathode active material (LiNi_{1/2}Mn_{3/2}O₄, average particle size: 3.98 μm) so as to form a membrane having a thickness shown in Table 1 in terms of Li₃PO₄, using a coater (MP-01 manufactured by Powrex Corporation), to coat the active material. Driving conditions thereof were: intake gas: nitrogen, intake gas temperature: 120° C., intake gas flow: 0.4 m³/h, rotating speed of a rotor: 400 rpm, and spraying speed: 4.5 g/min. After completion of the coating, heat treatment for 5 hours at a temperature shown in Table 1 was carried out in the air, to offer a composite active material. In the examples for which no heat treatment temperature is shown in Table 1, drying was carried out without heat treatment. The thickness of a coating layer, and the average particle size of the obtained composite active material were measured.

<Making all-Solid-State Battery>

### (Step of Preparing Cathode Active Material Layer)

A cathode mixture that was a raw material of a cathode active material layer was put into a vessel made from polypropylene (PP). This was stirred by an ultrasonic dispersive device (model: UH-50 manufactured by SMT Co., Ltd.) for 150 seconds in total, and shaken with a mixer (model: TTM-1 manufactured by Sibata Scientific Technology Ltd.) for 20 minutes in total, and thereby a slurry of a cathode active material was prepared.

Al foil as a cathode current collector layer was coated with this slurry of a cathode active material by the blade method using an applicator. This was dried up on a hot plate at 100° C. for 30 minutes, to offer a cathode active material layer formed on the Al foil, which was a cathode current collector layer.

The composition of the cathode mixture was as follows:
the composite active material made as described above was used as a cathode active material;
butyl butyrate was used as a dispersion medium;
VGCF (vapor-grown carbon fiber) was used as a conductive additive;
a butyl butyrate solution (5 mass %) containing a PVdF (polyvinylidene fluoride)-based binder as a binder was used; and
a Li₂S—P₂S₅-based glass ceramic (average particle size: 0.5 μm) containing LiI as a solid electrolyte was used.

(Step of Preparing Anode Active Material Layer)

An anode mixture that was a raw material of an anode active material layer was put into a vessel made from polypropylene (PP). This was stirred by an ultrasonic dispersive device (model: UH-50 manufactured by SMT Co., Ltd.) for 120 seconds in total, and shaken with a mixer (model: TTM-1 manufactured by Sibata Scientific Technology Ltd.) for 20 minutes in total, and thereby a slurry of an anode active material was prepared.

A Cu foil as a current collector layer was coated with this slurry of an anode active material by the blade method using an applicator. This was dried up on a hot plate at 100° C. for 30 minutes, to offer an anode active material layer formed on the Cu foil, which was an anode current collector layer.

The composition of the anode mixture was as follows:
natural graphite based carbon (manufactured by Mitsubishi Chemical Corporation, average particle size: 10 μm) was used as an anode active material;
butyl butyrate was used as a dispersion medium;
a butyl butyrate solution (5 mass %) containing a PVdF-based binder as a binder was used; and
a Li₂S—P₂S₅-based glass ceramic (average particle size: 0.5 μm) containing LiI as a solid electrolyte was used.

(Step of Preparing Each Solid Electrolyte Layer)

### Step of Preparing First and Second Solid Electrolyte Layers

An electrolyte mixture that was a raw material of a first solid electrolyte layer was put into a vessel made from polypropylene (PP). This was stirred by an ultrasonic dispersive device (model: UH-50 manufactured by SMT Co., Ltd.) for 30 seconds, and shaken with a mixer (model: TTM-1 manufactured by Sibata Scientific Technology Ltd.) for 30 minutes, and thereby a slurry of a first solid electrolyte was prepared.

An Al foil as a release sheet was coated with this slurry of a solid electrolyte by the blade method using an applicator. This was dried up on a hot plate at 100° C. for 30 minutes, to offer a first solid electrolyte layer formed on the Al foil. Further, the foregoing operation was repeated, to offer a second solid electrolyte layer formed on the Al foil.

The composition of the electrolyte mixture used for the first and second solid electrolyte layers was as follows:
a Li₂S—P₂S₅-based glass ceramic (average particle size: 2.0 μm) containing LiI was used as a solid electrolyte:
heptane was used as a dispersion medium; and
a heptane solution (5 mass %) containing a BR (butadiene rubber)-based binder was used as a binder.

Step of Preparing Middle Solid Electrolyte Layer

An electrolyte mixture that was a raw material of a middle solid electrolyte layer was put into a vessel made from polypropylene (PP). This was stirred by an ultrasonic dispersive device (model: UH-50 manufactured by SMT Co., Ltd.) for 30 seconds, and shaken with a mixer (model: TTM-1 manufactured by Sibata Scientific Technology Ltd.) for 30 minutes, and thereby a slurry of a middle solid electrolyte was prepared.

An Al foil as a release sheet was coated with this slurry of a solid electrolyte by the blade method using an applicator. This was dried up on a hot plate at 100° C. for 30 minutes, to offer a middle solid electrolyte layer formed on the Al foil.

The composition of the electrolyte mixture used for the middle solid electrolyte layer was as follows:
a Li₂S—P₂S₅-based hyaline (average particle size: 1.0 μm) containing LiI was used as a solid electrolyte:
heptane was used as a dispersion medium; and
a heptane solution (5 mass %) containing a BR-based binder was used as the binder.

(Step of Making Cathode Layered Body)

The foregoing cathode current collector layer, cathode active material layer, and first solid electrolyte layer were layered in the order mentioned. This layered body was set in a roll press, and pressed at 20 kN/cm (approximately 710 MPa) in a press pressure at 165° C. in a pressing temperature in a first pressing step, to offer a cathode layered body.

(Step of Making Anode Layered Body)

The foregoing second solid electrolyte layer, anode active material layer, and Cu foil as the anode current collector layer were layered in the order mentioned. This layered body was set in a roll press, and pressed at 20 kN/cm (approximately 630 MPa) in a press pressure at 25° C. in a pressing temperature in a second pressing step, to offer an anode layered body.

Further, the Al foil, which was a release sheet, the middle solid electrolyte layer formed on this Al foil, and the foregoing anode layered body having the second solid electrolyte layer, the anode active material layer and the Cu foil as the anode current collector layer were layered in the order mentioned. This layered body was set in a planar uniaxial press, and temporarily pressed at 100 MPa at 25° C. for 10 seconds. The Al foil was released from the middle solid electrolyte layer of this layered body, to offer an anode layered body further having the middle solid electrolyte layer layered therein.

(Step of Making all-Solid-State Battery)

The foregoing cathode layered body, and anode layered body further having the middle solid electrolyte layer layered therein were layered in the order mentioned. This layered body was set in a planar uniaxial press, and pressed at 200 MPa in a press pressure at 120° C. in a pressing temperature for 1 minute in a third pressing step, to offer an all-solid-state battery.

### Comparative Examples 1 to 6

All-solid-state batteries were made in the same manner as in Examples except that composite active materials made as follows were used therein.

First, 650 g of a Li₃PO₄ coating solution was made by adding ethanol (manufactured by Nacalai Tesque, Inc.) to 54.5 g of lithium nitrate (manufactured by Nacalai Tesque, Inc.) and 30.3 g of 85% phosphoric acid (manufactured by Nacalai Tesque, Inc.). Next, the Li₃PO₄ coating solution was sprayed over 1 kg of a cathode active material (LiNi_{1/2}Mn_{3/2}O₄, average particle size: 3.98 μm) so as to form a membrane having a thickness shown in Table 1 in terms of Li₃PO₄, using a coater (MP-01 manufactured by Powrex Corporation), to coat the active material. Driving conditions thereof were: intake gas: nitrogen, intake gas temperature: 120° C., intake gas flow: 0.4 m³/h, rotating speed of a rotor: 400 rpm, and spraying speed: 4.5 g/min. After completion of the coating, heat treatment for 5 hours at a temperature shown in Table 1 was carried out in the air, to offer a composite active material.

### Reference Example

As a reference example, the particle size of the cathode active material is shown in Table 1.

[Evaluation of Discharge Capacity]

The discharge capacity in each of Examples 4 to 9 and Comparative Examples 2 to 6, where heat treatment was carried out when the composite active material was made, was measured. The measurement method was as follows. The results are shown in Table 1.

### (Charge/Discharge Measurement)

First, conditioning was carried out so that CCCV charging was carried out at a rate of 0.1 C to reach 5.0 V and thereafter CCCV discharging was carried out at a rate of 1 C to reach 3.0 V. Then, CCCV charging/discharging was carried out at a rate of 1/3 C. The voltage range was set in 3.0-5.0 V, and the measurement temperature was set in 25° C. A discharge specific capacity (mAh/g) was calculated by dividing the obtained discharge capacity by the weight of the cathode active material layer.

TABLE 1

| | | | Heat | | |
|---|---|---|---|---|---|
| | | Thickness | treatment | Average | |
| | | of coating | temper- | particle | Discharge |
| | | layer | ature | size | capacity |
| | Process | (nm) | (° C.) | (μm) | (mAh/g) |
| Reference | — | — | — | 3.98 | — |
| example | | | | | |
| Comparative | One liquid | 4 | — | 34.27 | — |
| example 1 | | | | | |
| Comparative | One liquid | 4 | 350 | 34.27 | 3.72 |
| example 2 | | | | | |
| Comparative | One liquid | 4 | 400 | 34.27 | 10.72 |
| example 3 | | | | | |
| Comparative | One liquid | 4 | 450 | 34.27 | 16.88 |
| example 4 | | | | | |
| Comparative | One liquid | 4 | 500 | 34.27 | 23.46 |
| example 5 | | | | | |
| Comparative | One liquid | 4 | 550 | 34.27 | 27.43 |
| example 6 | | | | | |
| Example 1 | Two liquids | 6 | — | 3.70 | — |
| Example 2 | Two liquids | 8 | — | 3.33 | — |
| Example 3 | Two liquids | 10 | — | 3.19 | — |
| Example 4 | Two liquids | 10 | 100 | 3.19 | 77.68 |
| Example 5 | Two liquids | 10 | 200 | 3.19 | 98.80 |
| Example 6 | Two liquids | 10 | 300 | 3.19 | 104.13 |
| Example 7 | Two liquids | 10 | 400 | 3.19 | 102.38 |
| Example 8 | Two liquids | 10 | 500 | 3.19 | 90.16 |
| Example 9 | Two liquids | 10 | 600 | 3.19 | 59.66 |

[Results]

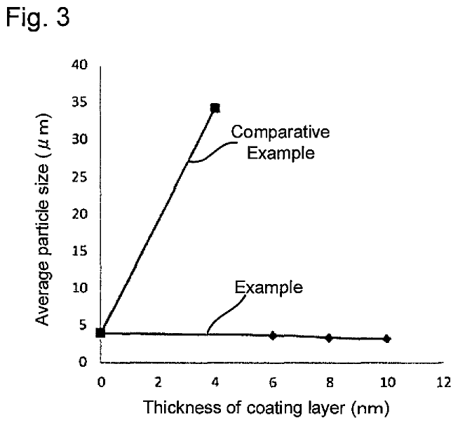

The results are shown in Table 1. FIG. 3 shows the relation between the thickness of the coating layer and the average particle size of the composite active material. As shown in Table 1 and FIG. 3, while the average particle size of the composite active material was approximately 3 μm irrelevantly to the thickness of the coating layer in each Example, the average particle size of the composite active material was approximately 34 μm even when the thickness of the coating layer was 4 nm in each Comparative Example. This was due to aggregation of the composite active material.

In each of Comparative Examples 1 to 6, the ethanol solution containing lithium nitrate and phosphoric acid, which was used as the Li₃PO₄ coating solution, was applied to the cathode active material. Further, heat treatment was carried out in Comparative Examples 2 to 6. Here, the comparison between Comparative Example 1 and the other comparative examples makes it clear that there was no difference between the average particle sizes of the composite active materials irrelevantly to the heat treatment. From this, the composite active material is believed to have been aggregated before the heat treatment. Since the reaction of lithium nitrate and phosphoric acid is promoted by heat treatment, there are also believed to have been much of unreacted lithium nitrate and phosphoric acid in the coating liquid before the heat treatment. Phosphoric acid, which has very high viscosity, is also believed to have increased the viscosity of the coating liquid. Thus, it can be presumed that the composite active material particles were aggregated in Comparative Examples due to the viscosity of the coating liquids before the heat treatment.

In contrast, in each of Examples 1 to 9, two coating liquids were used, to cause a neutralization reaction of LiOH and H₃PO₄ on a surface of the active material, to coat the surface of the active material with Li₃PO₄. Heat treatment is known to be unnecessary for this reaction. From the foregoing, it is believed that there were very little amounts of unreacted LiOH and H₃PO₄ on the surface of the active material before the heat treatment, and the viscosity of the coating liquids adhering to the surface of the active material was low in Examples. Thus, it can be presumed that aggregation of the composite active materials was suppressed in Examples.

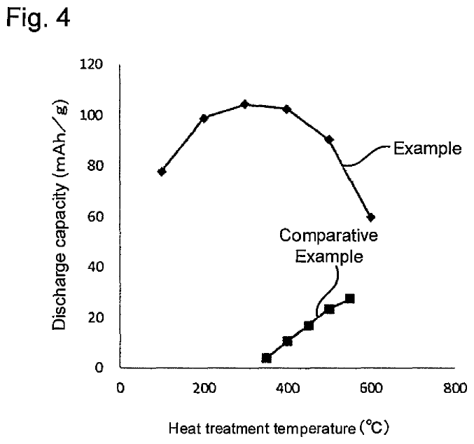

Further, FIG. 4 shows the relation between the heat treatment temperature and the discharge capacity. As seen from Table 1 and FIG. 4, Examples 4 to 9 each resulted in higher discharge capacities than Comparative Examples 2 to 6 because the composite active material was aggregated, to increase the average particle size in each Comparative Example. The increase in the average particle size of the composite active material reduced the contact area of the solid-solid interface between the composite active material and the electrolyte, which resulted in a lowered discharge capacity. Thus, Comparative Examples 2 to 6 each are believed to have resulted in lower discharge capacities than Examples 4 to 9.

As a result of the comparison between the discharge capacities in Examples 4 to 9, the discharge capacity in Example 5, where the heat treatment was carried out at 200° C., was higher than Example 4, where the heat treatment was carried out at 100° C. This is believed to be because the solvent (water) could not be completely removed in the heat treatment at 100° C. In contrast, Example 8, where the heat treatment was carried out at 500° C., resulted in a higher discharge capacity than Example 9, where the heat treatment was carried out at 600° C., and further Example 7, where the heat treatment was carried out at 400° C., resulted in a higher discharge capacity than Example 8. This is believed to be because the cathode active material reacts with the coating layer in heat treatment at high temperature. Therefore, it was found from these results that heat treatment at 200° C. to 400° C. makes it possible to suitably remove the solvent, and to suppress the reaction of the active material and the coating layer.

In Comparative Examples 2 to 6, the higher the heat treatment temperature was, the more the discharge capacity improved. It is believed that since the synthesis of the coating liquid of each Comparative Example was promoted by the heat treatment to form Li₃PO₄, formation of Li₃PO₄ was promoted more as the heat treatment temperature was higher, which suppressed the reaction of the composite active material and the electrolyte in the all-solid-state battery to improve the discharge capacity more. At that time, the reaction of the active material and the coating layer is believed to have progressed at the same time. It is however presumed that the effect of suppressing the reaction of the active material and the electrolyte was greater.

What is claimed is:

1. A method of producing a composite active material, wherein
the method causes a neutralization reaction of a basic Li source and an acidic PO₄ source on a surface of a particulate active material, to coat at least part of the surface of the active material with Li₃PO₄.

2. The method according to claim 1, the method comprising:
a Li source adhering step of adhering the Li source to the surface of the active material; and
a PO₄ source adhering step of adhering the PO₄ source to the surface of the active material, the PO₄ source adhering step following the Li source adhering step,
wherein the PO₄ source is H₃PO₄.

3. The method according to claim 1, the method further comprising:
a drying step of carrying out heat treatment on the active material, the surface of the active material being coated with Li₃PO₄, at a temperature at which the active material is not degraded.
